(19) United States
(12) Patent Application Publication
(10) Pub. No.: US 2005/0103066 A1
(43) Pub. Date: May 19, 2005

(54) Multi-point lock

(76) Inventors: Andries Johannes Marthinus Botha, Wellington (NZ); Christodoulos Toulis, Wellington (NZ); Ajay Michael Castelino, Auckland (NZ); Andrew Murray Gow, Wellington (NZ)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/991,727

(22) Filed: Nov. 17, 2004

(30) Foreign Application Priority Data
Nov. 18, 2003 (NZ) 529624
Nov. 18, 2003 (NZ) 529627

(51) Int. Cl. E05B 59/00; E05B 63/14

(52) U.S. Cl. 70/107

(57) ABSTRACT

A multi-point lock for a closure includes two or more of a latch (19,20), lift bolt (13) and at least one drive element (16,17) for operating a shoot bolt or remote deadbolt. A drive cam (15), a drive gear (14) and a toothed member (42) coupled to at least one of said lift bolt (13) and at least one said drive element (16,17), said toothed member (42) being in meshed engagement with the drive gear (14), said drive cam (15) being drivingly coupled with the drive gear (14) via a lost motion coupling (38,40). Rotation of the drive cam (15) in one direction can thus actuate the latch (19,20) and in the opposite direction actuate the drive gear (14) to cause movement of the lift bolt (13) and drive element (16,17).

### BACKGROUND TO THE INVENTION

This invention relates to a multi-point lock and more particularly a multi-point lock for a swing door.

Multi-point swing door locks are known. They provide a higher level of security due to the multiple locking points. Locks of this type also assist in maintaining a weather seal around the perimeter of the opening panel in negative pressure conditions.

As is known in the art the multiple locking points can be created by a the latch tongue, a deadbolt and one or more shoot bolts or remotely operated deadbolts. In a preferred form of a multi-point lock there may be two shoot bolts or remote deadbolts, one providing a locking point at an upper edge of the door and the other at a lower edge of the door. With shoot bolts the top shoot bolt will engage in a top cross member of the door frame and the lower shoot bolt into the floor or a lower cross-frame member of the door frame. Similar locking points can be achieved with remote deadbolts or alternatively the remote deadbolts will latch top and bottom of the door but into the vertical door frame member with which the latch tongue and/or deadbolt engage.

Some known locks suffer from being very complex in construction which results in multiple components. This leads to not only increased manufacturing costs but also costs associated with assembly of the lock.

The complexity of many known locks can lead to complexity in operation of the lock by a user. Thus, for example, there may be multiple levers, knobs, thumb turns not to mention a key locking cylinder, which need to be manipulated in order to achieve operation of the lock.

A functional requirement of such locks is that the remote deadbolts or shoot bolts need to be driven from the lock. This can lead to a further disadvantage with some known locks where it is difficult to achieve sufficient force (e.g. torque) to readily operate the remote deadbolts/shoot bolts. This, for example, can be a problem when the remote deadbolts/shoot bolts are operated by say a thumb turn or from the operation of a key cylinder.

Also the construction and configuration of some multi-point locks provide difficulty in achieving sufficient stroke for shoot bolts or, indeed, operation of remote deadbolts.

### SUMMARY OF THE INVENTION

It is an object of the present invention to provide a multi-point lock, which is of a simple construction and achieves effective multi-point locking.

It is a further object of the present invention to provide a multi-point lock where good torque characteristics can be generated for operation of remote deadbolts or shoot bolt.

Broadly according to one aspect of the present invention there is provided a multi-point lock including two or more of a latch mechanism, lift bolt and at least one drive element for operating a shoot bolt or remote deadbolt, a drive cam, a drive gear and a toothed member coupled to at least one of said lift bolt and at least one said drive element, said toothed member being in meshed engagement with the drive gear and said drive cam being drivingly coupled with the drive gear via a lost motion coupling.

In one preferred embodiment the drive member and lift bolt are formed integrally.

In a preferred form, the drive member is coupled to a drive element by a spigot on one of said drive member or drive element being slidingly engaged in an elongate slot in the other of said drive element or drive member.

Preferably a torsion spring applies a restorative torque to the drive cam.

In a preferred form the drive cam includes a sleeve that is engaged in an opening in the drive gear whereby relative movement of the drive cam and drive gear can occur about a common axis of rotation. The opening includes at least one cut away portion in which a lug projecting from the sleeve can slidingly move between limits formed by end walls or abutments in the cut away position.

The lock preferably further includes a deadlocker that is operable via a key operated cylinder. A deadlocker button is operable by a cam of the key cylinder to release the deadlocker whereby the cylinder cam can move the deadlocker to a deadlocking position. Preferably there is included a restraining means which restrains the deadlocker button from releasing unless the drive gear has moved to a predetermined position.

According to a second broad aspect of the invention there is provided a multi-point lock which includes two or more of a latch mechanism, lift bolt and at least one drive element for operating a shoot bolt or remote deadbolt, the latch mechanism having a latch tongue characterised in that the latch mechanism further includes a latch chassis to which the latch tongue, as a separate element, is attached.

In one preferred form the latch tongue is removably attached to the latch chassis.

According to a third broad aspect of the invention there is provided a multi-point lock which includes two or more of a latch mechanism, lift bolt and at least one drive element for operating a shoot bolt or remote deadbolt, a drive cam with which, in use, a lever handle can be coupled by a shaft the drive cam being movable by the shaft in one direction to operate said latch mechanism and in a second direction to operate the lift bolt and said at least one drive element.

### BRIEF DESCRIPTION OF THE DRAWINGS

In the following more detailed description of a preferred embodiment of the invention reference will be made to the accompanying drawings in which:—

FIG. 1 is an exploded perspective view of the multi-point lock showing the various component parts thereof,

FIG. 2 is a perspective view of the lock with one cover plate removed and the latch tongue engaged with a strike,

FIG. 3 is a partially sectioned elevation view of the lock as shown in FIG. 2 but without the strike and showing components that prevent the key cylinder from activating the deadlocker when the lift bolt (deadbolt) is not thrown,

FIG. 3a is a perspective view of the deadlocker button of the lock,

FIG. 3b is a perspective view of the bottom rack of the lock,

FIG. 4 is a partial elevation view similar to FIG. 3 but showing only part of the lock and with the lock in the configuration where a handle (not shown) has retracted the latch tongue,

FIG. 5 is a further elevation view partially section of the lock showing the lock in a configuration where the top and bottom racks have been extended and the deadbolt is in the locking position,

FIG. 6 is an elevation view the same as FIG. 5 but showing the retraction of the deadbolt and racks,

FIG. 7 is a detailed part section view of the lower end of the lock showing activation of the deadlocks via the key cylinder,

FIG. 8 is a further view partially sectioned of the lock in the locking configuration of FIG. 5 and showing to one side the deadlocker component of the lock,

FIG. 9 is a view similar to FIG. 7 but showing retraction of the deadlocker via the key cylinder,

FIG. 10 is a perspective view of the top rack showing an embodiment of a threaded mounting for attachment of an operating rod or connecting element for a shoot bolt/remote deadbolt,

FIG. 11 is an enlarged view of detail A of FIG. 10,

FIG. 12 is an elevation view of the top rack shown in FIG. 10, and

FIG. 13 is a side elevation view of the top rack as shown in FIGS. 10 and 12.

### DETAILED DESCRIPTION OF A PREFERRED EMBODIMENT OF THE INVENTION

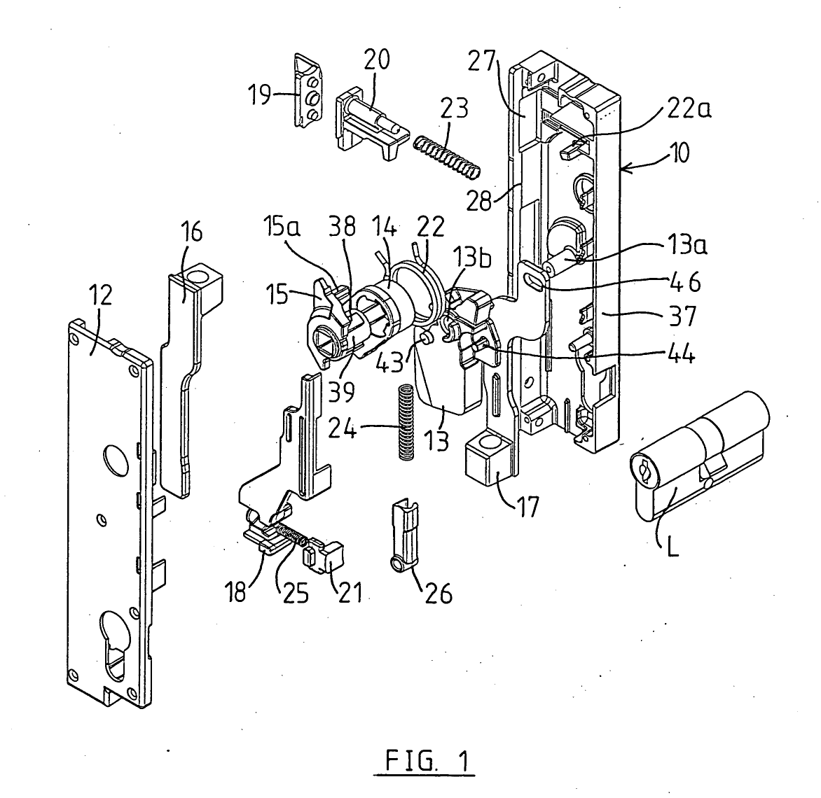

Referring firstly to FIG. 1 of the drawings, there is shown a multi-point swing door lock in exploded form. This illustrates the componentry of the lock. The components, other than the lock cylinder and spring components are all designed so that they can be manufactured by diecasting from, for example, zinc diecasting material.

As will be apparent to those skilled in the art from the following description some of the components are multifunctional which provides for a minimum number of component parts. Also as will be apparent from the following description, ease of assembly not only arises from the minimum number of parts but also the use of a modular torsional spring assembly.

The lock according to the illustrated form includes a housing 10 on which is fitted a cover 12 once the component parts have been assembled within the housing 10. Pivotally mounted with the housing is a lift bolt or deadbolt 13. This is pivotally mounted by pin 13a, which projects from the floor of housing 10 and engages in bore 13b of the lift bolt 13.

The modular torsional spring assembly, referred to above, is made up of a drive gear 14, drive cam 15 and a drive torsion spring 22. These components can be preassembled into a unit.

The lock further includes a top rack 16 and bottom rack 17. As will hereinafter be described racks 16 and 17 can be connected (by connecting rods or elements) to remote deadbolts or shoot bolts (not shown).

A deadlocker 18 and deadlocker button 21 co-operate with a key cylinder L to provide a deadlocking function as will hereinafter be described.

The primary latching function of the lock is achieved by a latch chassis 20 to which a latch tongue 19 is fitted. The assembly 19, 20 is biased by a latch spring 23.

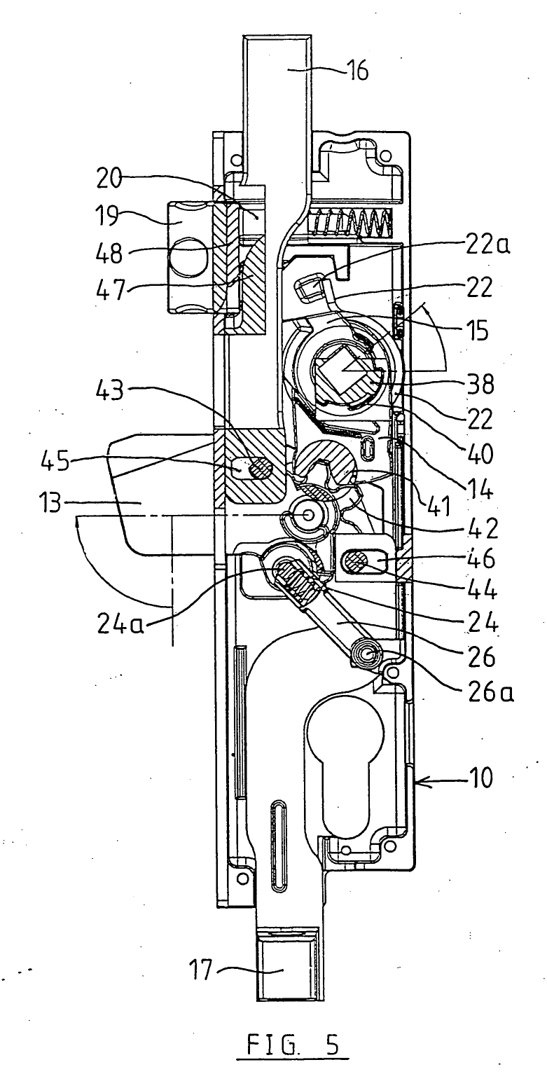

The remaining components of the lock comprise a lift bolt spring 24 and a lift bolt spring guide 26. The spring 24 engages within the guide 26 and engages at its distal end with a spigot 24a on the lift bolt 13. The guide 26 has a bifurcated end part which engages with spigot 24a (see FIG. 5). The opposite end of guide 26 is pivotally engaged on a pin 26a fixed to and extruding from the floor of housing 10.

Operation of the multi-point spring door lock is of a simple and straightforward nature. The functions of the lock are controlled by the following actions:—
Drive cam 15 rotates clockwise.
Drive cam 15 rotates anti-clockwise
Key in lock cylinder L turns clockwise.
Key in lock cylinder L turns anti-clockwise.

The multiple locking points provided by the lock are the latch tongue 19, lift bolt 23 and shoot bolts or remote deadbolts connected to racks 16 and 17.

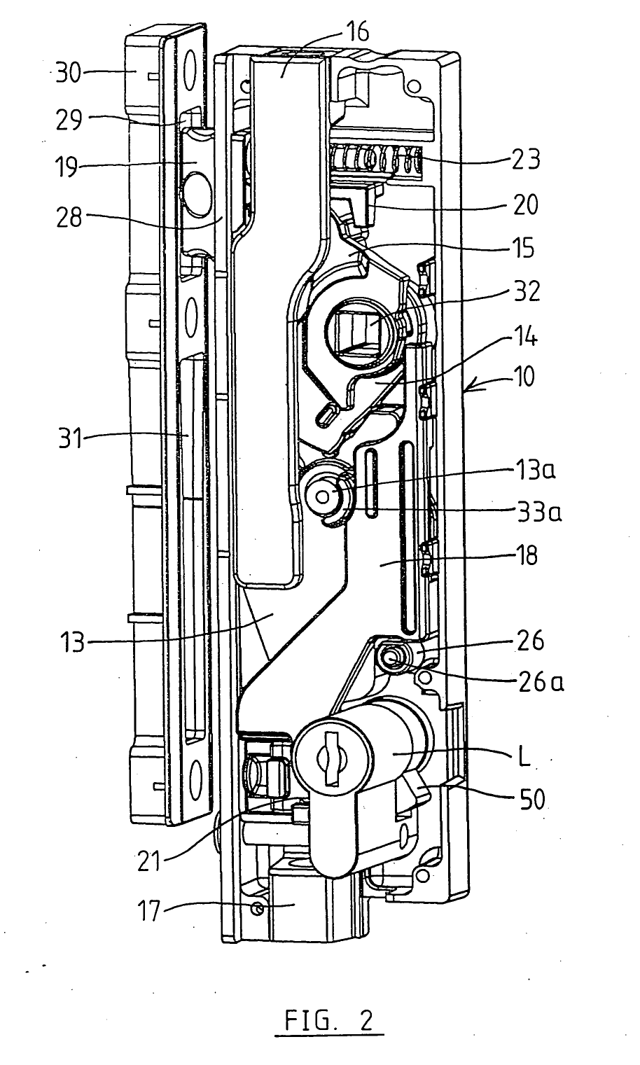

FIG. 2 of the drawing shows the component parts of the lock assembled in the housing 10. The latch tongue 19 projects from the housing 10 through opening 27 in wall 28 of the housing 10. As illustrated in FIG. 2 the latch tongue 19 engages in a latch cavity 29 in strike 30. This strike 30 further includes a cavity 31 in which the lift bolt 13 engages when in the “thrown” position of FIG. 5.

One advantage provided by the lock according to the present invention is that the latch tongue 19 is a separate component to latch chassis 20. Therefore, a different “handed” latch tongue 19 can be fitted, as required, to the latch chassis 20. In a preferred form of the invention the latch tongue is reversible. Also a different size latch tongue 19 can be fitted so as to increase or decrease, as may be required, the extent by which the latch tongue 19 projects beyond wall 28 when the latch tongue 19 is in its protruding position. This protruding position is its natural position given the biasing effect of spring 23 acting on the latch chassis 20.

By being able to adjust the extent that the latch tongue 19 protrudes the “back set” of the lock can be adjusted as may be required for particular applications i.e. the distance from the axis of rotation of the drive cam 15 to the edge of the door.

To more particularly describe the lock and the interaction of the component parts, reference will now be made to the operation of the lock.

The lock is self-latching. When the door is shut the latch tongue 19 rides against the strike 30 fixed on the door frame. This forces the latch tongue 19 back into the housing 10 against the biasing action of the latch spring 23. When the door is completely shut the profile of the latch tongue 19 will be aligned with the latch cavity 29 thus under the influence of the spring 23 the latch tongue 19 will engage into the latch cavity 29. The door is accordingly self-latched into the closed and latched position as is shown in FIG. 2.

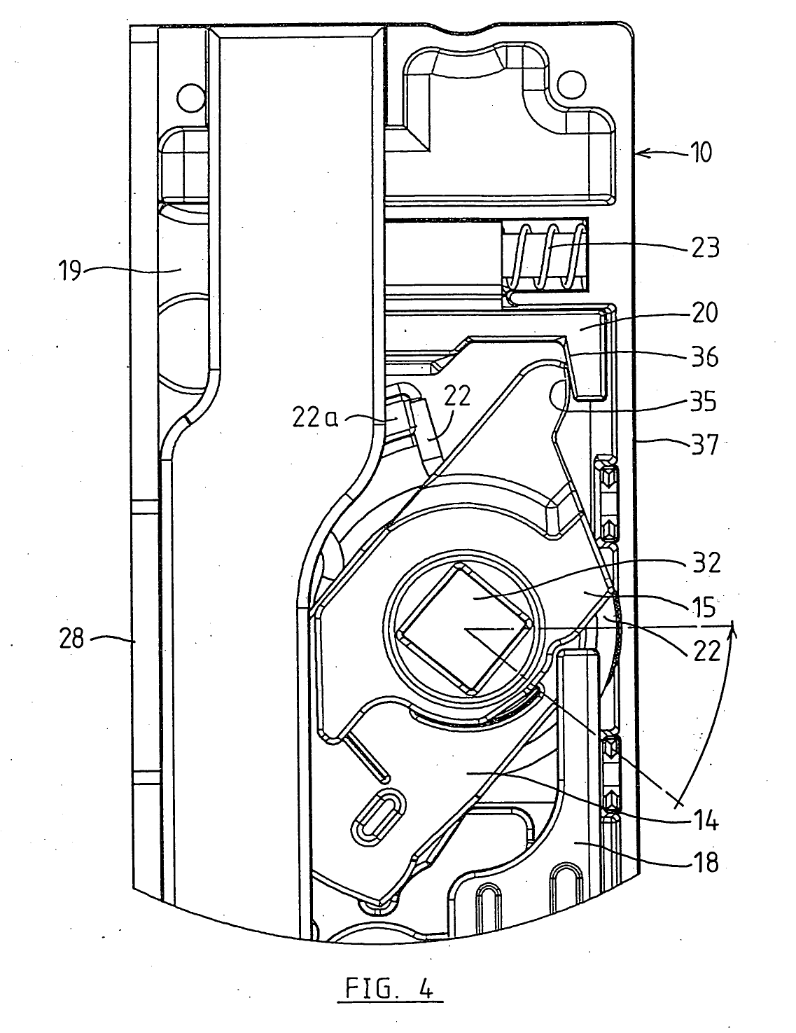

In this position the drive cam 15 can be rotated 40° clockwise (see FIG. 4) to unlatch the door. This rotation of the drive cam 15 is achieved in a conventional manner by a square drive shaft (not shown) engaged through the square bore 32 in the drive cam 15. Rotation of the drive shaft will be achieved by moving (rotating) a lever handle connected to the drive shaft. The lever handle will form part of lock furniture fixed to the surface of the door.

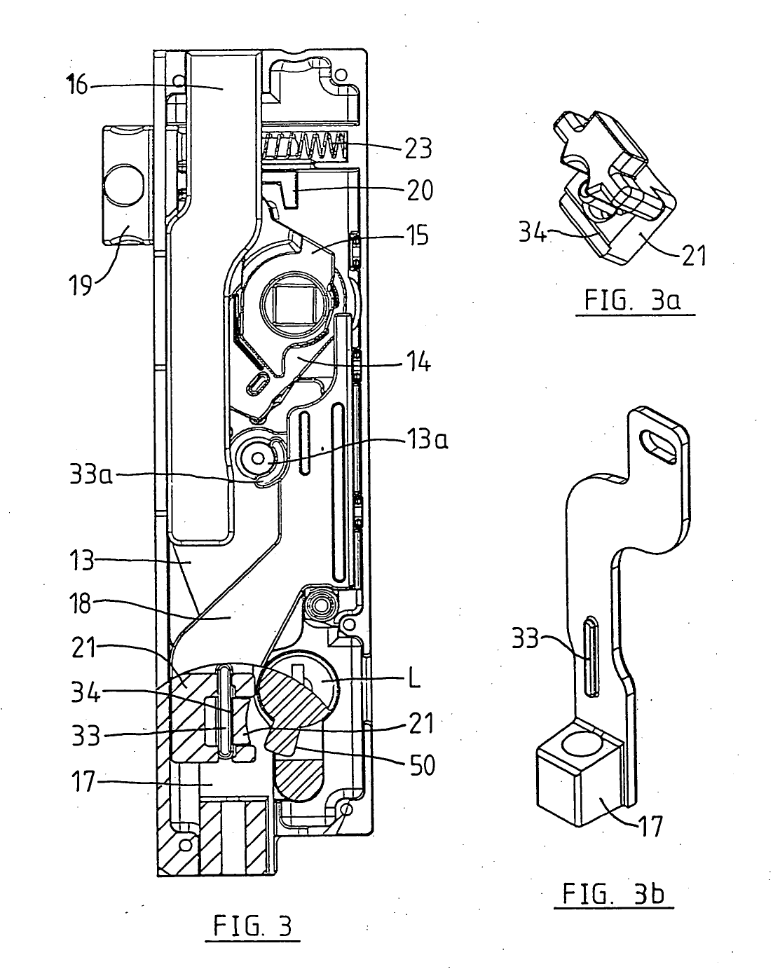

The key cylinder L cannot be activated in this position since the deadlocker button 21 (see FIGS. 3 and 3a) is prevented from retracting due to a rib 33 (see FIGS. 3 and 3b) on the bottom rack 17 contacting surface 34 (see FIG. 3a) on the deadlocker button 21. In addition, the deadlocker 18 is prevented from being lifted due to rib 33a on the lift bolt 13 (see FIG. 3) engaging with a surface of the deadlocker 18.

Once again from the same configuration of the door lock as shown in FIG. 2, the drive cam 15 can be rotated 40° anti-clockwise (see FIG. 5). This action moves the lift bolt 13 into engagement in cavity 31 of the strike 30 and throws (moves) racks 16 and 17 in order to move shoot bolts or remote deadbolts, connected therewith, into the latching position.

When the drive cam 15 is rotated 40° clockwise (see FIG. 4) surface 35 on the drive cam 15 acts against surface 36 on the latch chassis 20. As shown more clearly in FIG. 4 this causes the latch chassis 20 to be moved toward wall 37 of the housing 10 with the fully retracted position being achieved when contact is made between the latch chassis 20 and wall 27. The lock is now in the unlatched position and the door can be opened. The drive cam 15 is returned to its rest or neutral position by the action of the cam torsion spring 22 on drive cam spigot 15a.

If the drive cam 15 is rotated 40° anti-clockwise (see FIG. 5) this drives the drive gear 14 (i.e. rotates drive gear 14) via the drive lugs 38, which are formed on sleeve 39 of the drive cam 15. As can be seen in FIGS. 1 and 5, the sleeve 39 engages in a bore in drive gear 14, this bore having multiple cut outs 40 in each of which a drive lug 38 is engaged and can move. As shown in FIG. 5 the drive lugs 38 have moved toward one end of the cut out 40 to engage with a wall surface thereby enabling rotation of the drive cam 15 to apply a rotational force to the drive gear 14.

The length of cut out 40 allows lug 38 to move toward the other end of the cut out 40 when the drive cam 15 is rotated clockwise (as described above). This “lost motion” thus permits drive cam 15 to move independent of drive gear 14 when the drive cam 15 is simply operating latch chassis 20.

The drive gear 14 rotates the lift bolt 13 through 90° (see FIG. 5) via the gear teeth 41 of drive gear 14 inter-engaging with teeth 42 of the lift bolt 13. This movement of the lift bolt 13 is aided by the bias spring system formed by lift bolt spring 24 and lift bolt spring guide 26. As the lift bolt is rotated the relative positions of pin 13a, spigot 24a and spigot 26a causes spigot 24a to move along the bifurcated end of guide 26 to compress the spring. Once the assembly has moved “over centre” the spring 24 applies a force to spigot 24a to drive lift bolt 13 to its thrown position.

The lift bolt 13 drives the racks 16 and 17 via its drive spigots 43 and 44. As can be seen in FIG. 5 these drive spigots 43 and 44 are moveable along elongate slots 45 and 46 respectively in the top and bottom racks 16 and 17. As shown in FIG. 5 the racks 16 and 17 are driven to protrude a distance which in the illustrated lock is about 22 mm from each end of the housing 10. Accordingly the door will now be latched by (a) latch tongue 19, (b) bolted via shoot bolts/remote deadbolts driven by racks 16 and 17 and (c) bolted by the lift bolt 13 engaging in strike 30.

The drive cam 15 is returned to its rest or neutral position by the drive cam torsion spring 22. One leg of spring 22 engages with projection 22a fixed with the housing 10 and the other leg with a projection 15a on drive cam 15. Thus as drive cam 15 moves it sets up a strain in spring 22 which creates the restorative force.

By referring to FIG. 5, it will also be seen that the top rack 16 has on its underside (when viewed in the direction of, for example, FIG. 5) a surface formed by a ledge 47 which engages with a flanged portion 48 of latch chassis 20 so as to lock the latch assembly 19 and 20.

When the lift bolt 13 is thrown and the racks 16 and 17 are extended the drive cam 15 can be rotated 40° clockwise to retract the lift bolt 13 and racks 16 and 17 and unlatch the door.

Thus when the drive cam 15 is rotated 40° clockwise it drives the drive gear 14 via the drive lugs 38. Accordingly, the drive gear 14 rotates the lift bolt 13 90° anti-clockwise via the intermeshing of gear teeth 41 and 42. Once again the lift bolt 13 is aided in its movement by the bias spring system 24 and 26 as previously described.

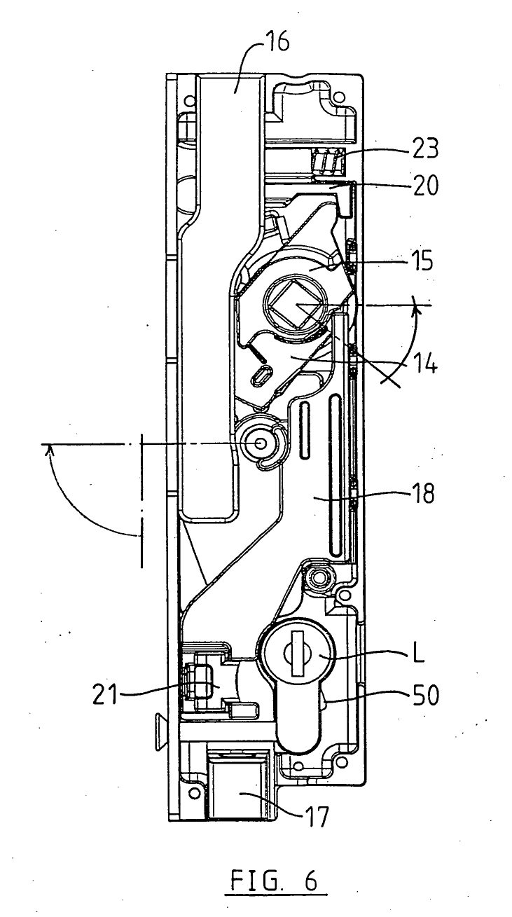

The lift bolt 13 retracts the racks 16 and 17 via the drive spigots 43 and 44 moving in slots 45 and 46. The racks 16 and 17 therefore retract 22 mm. Also, as described previously surface 35 of the drive cam 15 acts against surface 36 of the latch chassis 20 and as a result the latch tongue 19 is retracted. The door is thus unbolted and unlatched and can be opened (see FIGS. 4, 5 and 6).

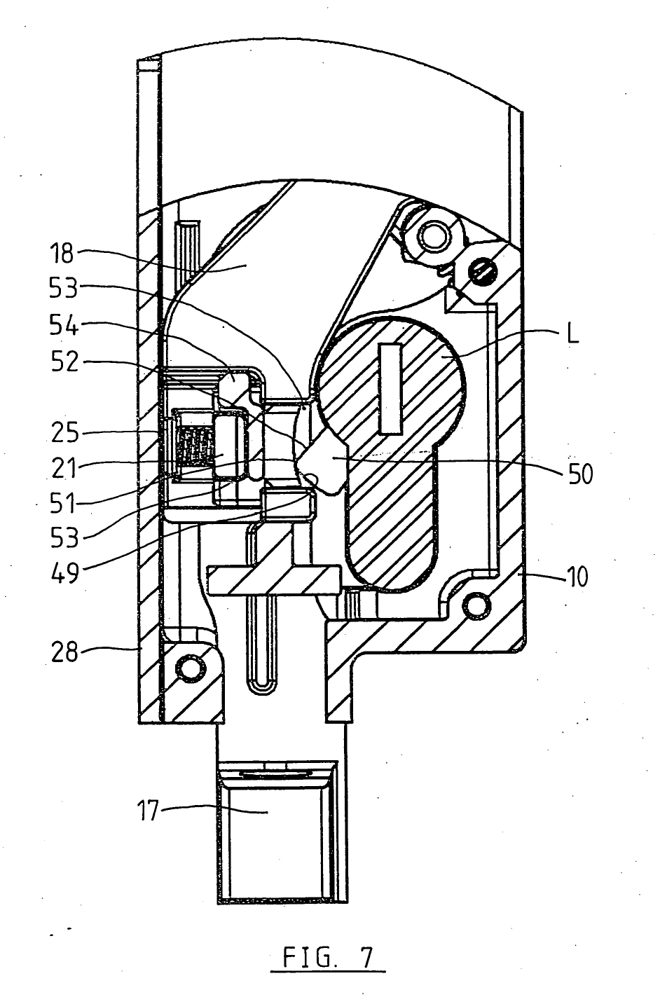

Alternatively, once the lift bolt 13 is thrown and the racks 16 and 17 extended the key cylinder L can be turned clockwise to lock the system. Thus if the key cylinder L is turned clockwise through 360°, as the key turns, surface 49 (see FIG. 7) of the cylinder cam 50 contacts against surface 51 of the deadlocker button 21. As the cylinder cam 50 rotates it pushes the deadlock button 21 against the deadlock button spring 25. Surface 52 of the cam 50 contacts surface 53 of the deadlocker 18 and pushes it upwards.

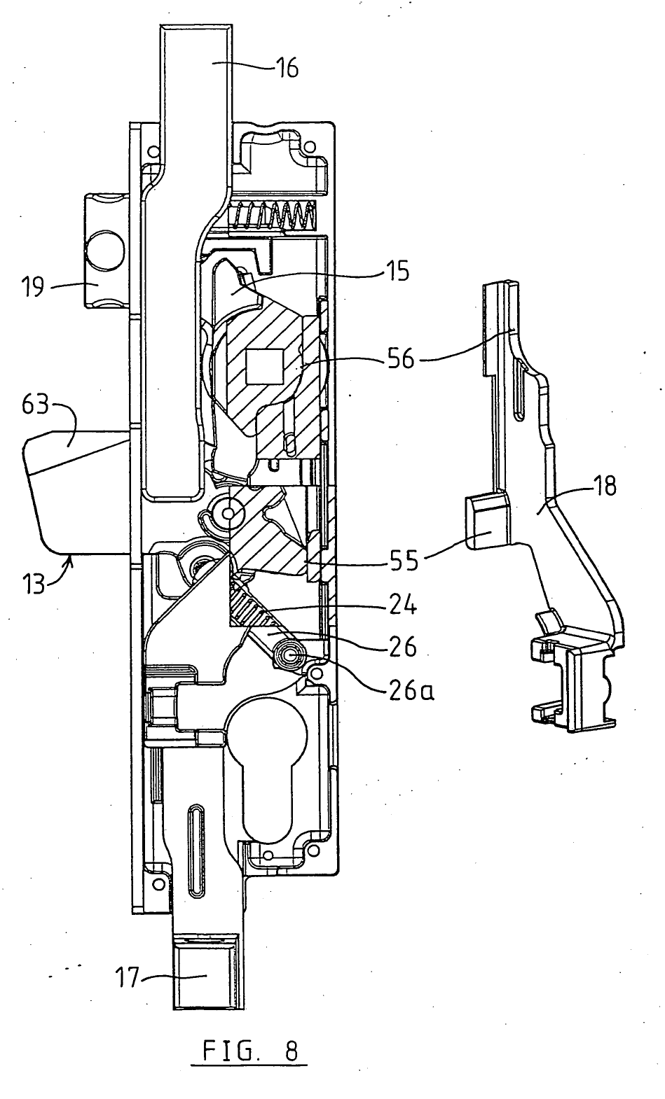

When the deadlocker 18 has moved a determined distance (in the illustrated form of the invention a distance of about 13.5 mm) the deadlock button surface 53 rests against the surface 54 on the lock cover 12 which prevents it from being pushed down. The lift bolt 13 and racks 16 and 17 are now deadlocked. The deadlocker 18 locks the lift bolt 13 at surface 55 (see FIG. 8) and the drive cam 15 at surface 56 (also see FIG. 8).

Once the system is locked the drive cam 15 cannot be rotated. To unlock the system the key cylinder L is operated by turning the key anti-clockwise through 360°. As the key turns surface 49 of the cylinder cam 50 contacts against surface 51 of the deadlocker button 21. As the cylinder cam 50 rotates it also pushes the deadlocker button 21 against the deadlocker button spring 25. Surface 58 of the cylinder cam 50 contacts surface 59 of the deadlocker 18 and retracts it.

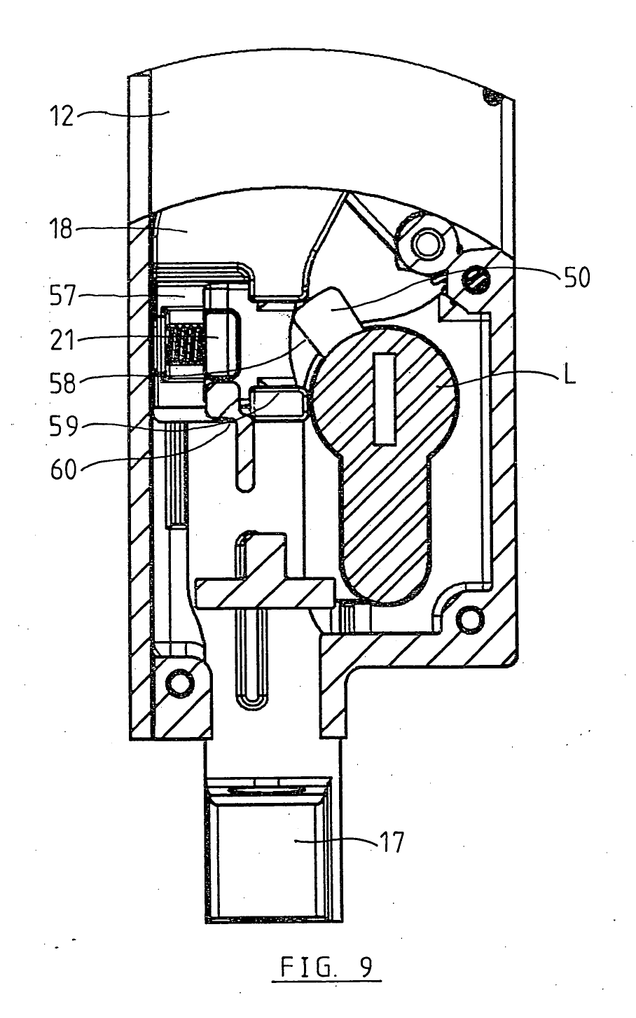

When the deadlocker 18 has retracted by the previously described amount (i.e. about 13.5 mm) the deadlocker button 21 rests against the surface 60 on the cover 12 which prevents it from being extended. The lift bolt 13 and racks 16 and 17 are now unlocked (see FIG. 9). The door can now be opened by moving the drive cam 15 through 40° clockwise to retract the lift bolt 13 and racks 16 and 17 as well as retract the latch 19 from the strike.

It will be appreciated that the anti-clockwise movement of the drive cam 15 is achieved by lifting of the lever handle (not shown) which is connected via the square drive shaft (not shown) to the drive cam 15. Thus the leverage achieves good torque generation for achieving extension of the lift bolt 13 and causing the racks 16 and 17 to operate the shoot bolts/remote deadbolts. Consequently significant strength requirements on the part of the user will not be required.

As all actions for operating the lock (other than deadlocking via key cylinder L) are achieved by manipulation of the lever handle of the lock furniture associated with the lock the lock is straightforward and easy to operate.

It will also be appreciated by those skilled in the art that the lock can be readily adapted for end user requirements or user applications. For example, the lift bolt 13 could be replaced by an element which includes only the gear teeth 42 and drive spigots 43 and 44 so as to achieve operation of the lock but without the presence of a lift bolt 13 protruding during such operation.

Alternatively in an application where a latch tongue 19 is not required either the latch tongue 19 could be omitted or the entire latch assembly 19, 20 and 23.

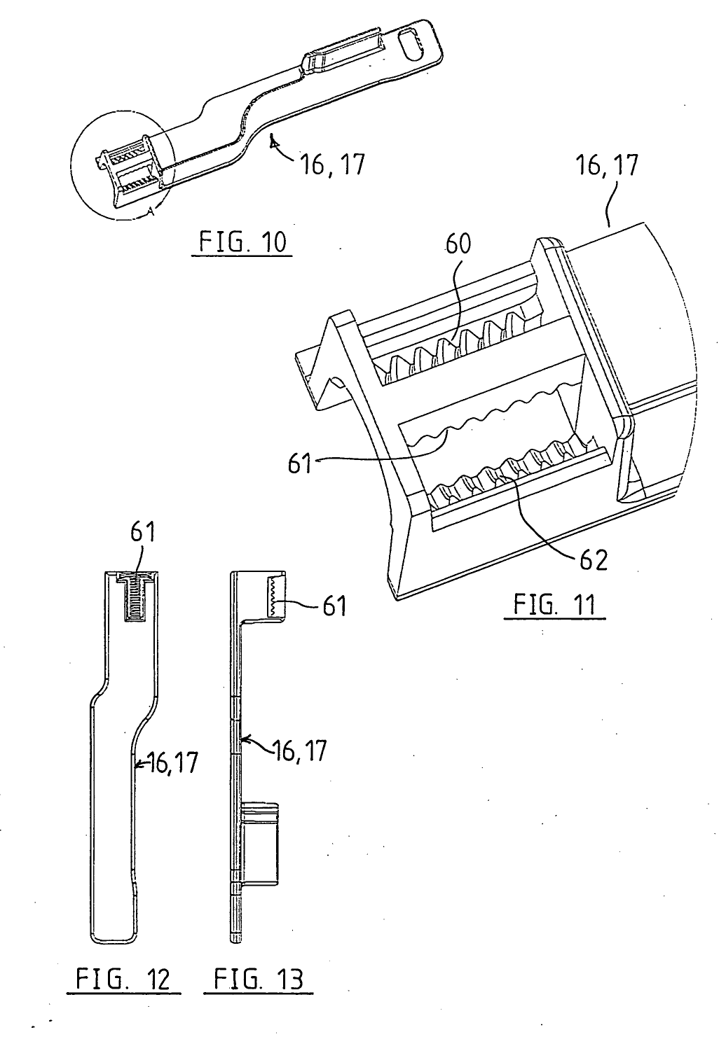

FIGS. 10-13 illustrate one means of connecting the operating element which extends from the racks 16 or 17 to a shoot bolt or remote deadbolt. The method of connecting is via a thread which is formed by three separate thread profiles 60, 61 and 62 which combine to form a total thread profile with which a thread end of a connecting rod or the like can be engaged.

The spatial array and configuration of the three thread sections 60-62 enables the rack to be diecast (as previously described) or injection moulded. The thread design enables the thread to be cast or moulded in a simple open and shut tool without the requirements for an expensive unscrewing die or a second operation (tapping) in the manufacturing process. The design also provides ample thread engagement and strength for the intended use of the lock part.

A further feature of the lock is the ramped profile 63 of the lift bolt 13. As can be seen, for example, in FIG. 8 the leading part (relative to the strike 30) has a portion 63 of reducing thickness toward the edge of cavity 31 in strike 30. Thus, as the lift bolt progresses toward its fully thrown position the edge of cavity 31 rides over ramp 63 thereby applying a force to the door (via lift bolt 13) to cause the door to achieve compression or better compression of weather seals. The net effect is a “lever compression lock” action.

1. A multi-point lock including two or more of a latch mechanism, lift bolt and at least one drive element for operating a shoot bolt or remote deadbolt, a drive cam, a drive gear and a toothed member coupled to at least one of said lift bolt and at least one said drive element, said toothed member being in meshed engagement with the drive gear, said drive cam being drivingly coupled with the drive gear via a lost motion coupling.

2. A lock as claimed in claim 1 wherein the drive gear and lift bolt are formed integrally.

3. A lock as claimed in claim 1 or 2 wherein the drive gear is coupled to a drive element by a spigot on one of said drive gear or drive element being slidingly engaged in an elongate slot in the other of said drive element or drive gear.

4. A lock as claimed in claims 1 or 2 wherein a torsion spring applies a restorative torque to the drive cam.

5. A lock as claimed in claim 1 wherein the drive cam includes a sleeve that is engaged in an opening in the drive gear whereby relative movement of the drive cam and drive gear can occur about a common axis of rotation.

6. A lock as claimed in claim 5 wherein the opening includes at least one cut away portion in which a lug projecting from the sleeve can slidingly move between limits formed by end walls or abutments in the cut away portion.

7. A lock as claimed in claim 1 further including a deadlocker that is operable via a key operated cylinder.

8. A lock as claimed in claim 7 wherein a deadlocker button is operable by a cam of the key cylinder to release the deadlocker whereby the cylinder cam can move the deadlocker to a deadlocking position.

9. A lock as claimed in claim 8 wherein there is further included a restraining means which restrains the deadlocker button from releasing unless the drive gear has moved to a predetermined position.

10. A lock as claimed in claim 1 wherein the latch mechanism includes a latch chassis to which a latch tongue is removably attached.

11. A lock as claimed in claim 6 wherein the cam is adapted to combine with a drive shaft to which a lever handle can be attached.

12. A lock as claimed in claim 1 wherein the cam includes a shaft engagement means, the cam being mounted for rotation by a shaft engaged therewith in a first direction to operate the latch mechanism and in a second direction to operate the toothed member.

13. A lock as claimed in claim 1 further including an over centre spring coupled between the drive gear and a fixed mounting.

14. A multi-point lock which includes two or more of a latch mechanism, lift bolt and at least one drive element for operating a shoot bolt or remote deadbolt, a drive cam with which, in use, a lever handle can be coupled by a shaft the drive cam being movable by the shaft in one direction to operate said latch mechanism and in a second direction to operate the lift bolt and/or said at least one drive element.

15. A lock as claimed in claim 14 wherein the drive cam is preassembled with a drive gear and a drive torsion spring in a modular torsional spring assembly which is mounted in the lock such that relative rotational and combined rotational movement of the drive cam and drive gear can be selected by movement of the shaft in said first and second directions.

16. A lock as claimed in claim 15 wherein the drive cam and drive gear are coupled such that upon initialisation of movement in the second direction movement of the drive cam relative to the drive gear occurs before combined rotational movement thereof commences.

17. A lock as claimed in claim 16 wherein the drive cam includes a sleeve that is engaged in an opening in the drive gear said opening including at least one cut away portion in which a drive lug of the sleeve slidingly engages for movement between limits formed by end walls or abutments in the cut away portion.

18. A lock as claimed in claim 17 wherein the drive torsional spring is engaged between the drive cam and a fixed point in the lock.

19. A lock as claimed in claim 18 wherein the drive gear is formed integrally with the lift bolt.

20. A lock as claimed in claim 19 further including a deadlocker and a key operated cylinder, the deadlocker being operable by the key operated cylinder.

21. A lock as claimed in claim 20 further including a deadlocker button operable by the key cylinder to release the deadlocker and thereby permit the deadlocker to be moved by the key cylinder into a deadlocking position.

22. A lock as claimed in claim 21 wherein the latch mechanism includes a latch chassis to which a latch tongue is removably attached.

23. A lock as claimed in claim 1 wherein the or each drive element includes a threaded portion into which a threaded end of a shoot bolt or connecting rod can be threadingly engaged.

24. A lock as claimed in claim 23 wherein said threaded portion is formed by a plurality of separate thread profiles which collectively form a total thread profile for said threaded end.

25. A lock as claimed in claim 24 wherein the drive element is of die cast or moulded construction.

26. A lock as claimed in claim 1 or 2 wherein the lift bolt incorporates a ramped profile in a leading part of the lift bolt.
